(19) United States
(12) Patent Application Publication
(10) Pub. No.: US 2016/0206148 A1
(43) Pub. Date: Jul. 21, 2016

(54) Portable BBQ grill

(71) Applicant: RKS DESIGN, INC., Thousand Oaks, CA (US)

(72) Inventors: Ravi Sawhney, Thousand Oaks, CA (US); Lance Hussey, Thousand Oaks, CA (US)

(21) Appl. No.: 14/998,247

(22) Filed: Dec. 26, 2015

Related U.S. Application Data
(60) Provisional application No. 62/097,542, filed on Dec. 29, 2014.

(51) Int. Cl. A47J 37/07

(52) U.S. Cl. CPC A47J 37/0763; A47J 2037/0777

(57) ABSTRACT

Described and is a portable BBQ grill. The portable BBQ grill includes a pair of grill housings, each grill housing pivotally connected with a lower housing and having a grilling surface. The grilling housings are pivotal from a closed configuration in which the grilling surfaces face one another and an open configuration in which the grilling surfaces are substantially horizontal and exposed for grilling. A pair of handles are also included. Each handle is pivotally attached with one of the grill housings. When in the closed configuration, the pair of handles pivot toward one another to operate as a carrying handle for the portable BBQ grill, and when in the open configuration, the pair of handles pivot downward to provide a pair of legs that, in conjunction with the lower housing provide three legs upon which the portable BBQ grill rests.

### CROSS-REFERENCE TO RELATED APPLICATIONS

This is a non-provisional application of U.S. Provisional Application No. 62/097,542, filed on Dec. 29, 2014.

### BACKGROUND OF THE INVENTION

(1) Field of Invention

The present invention relates to a BBQ grill and, more particularly, to a portable BBQ grill.

(2) Description of Related Art

BBQ grills have long been known in the art. BBQ grills are typically large installations that are used in a backyard or other fixed location. Camping stoves are commonly implemented as portable cooking surfaces; however, such camping stoves are often difficult to carry and transport.

Thus, a continuing need exists for a portable BBQ grill that is easy to carry and transport.

### SUMMARY OF INVENTION

The present invention relates to a BBQ grill and, more particularly, to a portable BBQ grill. The BBQ grill includes a pair of grill housings, each grill housing pivotally connected with a lower housing and having a grilling surface. The grilling housings are pivotal from a closed configuration in which the grilling surfaces face one another and an open configuration in which the grilling surfaces are substantially horizontal and exposed for grilling. A pair of handles are also included. Each handle is pivotally attached with one of the grill housings, wherein when in the closed configuration, the pair of handles pivot toward one another to collectively operate as a carrying handle projecting upward from the portable BBQ grill, and wherein when in the open configuration, the pair of handles pivot downward to provide a pair of legs that, in conjunction with the lower housing, provide three legs upon which the portable BBQ grill rests.

In another aspect, the BBQ grill further includes a pair of drip trays, each of which is formed to fit within a grill housing. Each drip tray includes a bottom portion and a side catch portion such that when the portable BBQ grill is in the open configuration, the bottom portion rests below the grilling surface and the side catch portion acts as a side wall to the drip tray and when the BBQ grill is folded into the closed configuration, with the grilling surfaces facing each other, the side catch portions are positioned at the bottom of the drip tray and operate as basins to catch any grease or other material that may drip or slide down the drip tray.

In yet another aspect, the grilling surfaces are removable grilling surfaces that are detachably attachable with the respective grill housing.

In another aspect, the BBQ grill includes a pair of burner assemblies, each burner assembly being positioned within a grill housing and pivotally connected with the lower housing.

Additionally, the lower housing is formed to receive and contain a gas canister therein. The lower housing further includes a pair of gas controls operable for selectively directing gas to the pair of burner assemblies.

In yet another aspect, the BBQ grill includes a pair of ignition assemblies.

Each ignition assembly is pivotally connected with the lower housing and includes an ignition rod positioned proximate the burner assembly.

Further, the BBQ grill includes an ignitor button and spark generator attached with the lower housing. Additionally, a wire is electrically connected with and between the spark generator and the ignition rod, with the wire partially concealed within the ignition assembly.

In yet another aspect, the ignition assembly includes a bracket that is affixed with the ignition assembly and rests beneath the burner assembly, such that when the burner assembly is positioned downward and into the grill housing, the burner assembly contacts and rests against the bracket which secures the burner assembly proximate the ignition rod.

In yet another aspect, the BBQ grill includes one or more conduits connected with the lower housing, each conduit ending in a rotational coupling. Further, each burner assembly includes a coupling sleeve that slides into engaging contact (either into or over) with the rotational coupling to provide a sealed and pivotal connection between the rotational coupling and the coupling sleeve.

In another aspect, a grill housing bracket is affixed with each grilling housing and a pair of lower housing brackets are affixed with the lower housing, such that the grill housing brackets are pivotally connected with the corresponding lower housing brackets to provide the pivotal connection between each grill housing and the lower housing. Further, the burner assembly and coupling sleeve are shaped such that the coupling sleeve passes laterally through the grill housing bracket to engage and connect with the rotational coupling to allow the burner assemblies to rotate up and down between the open and closed configurations.

Finally, as can be appreciated by one in the art, the present invention also comprises a method for forming and using the invention described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a top, perspective-view illustration of a portable BBQ grill according to various embodiments of the present invention, depicting the BBQ grill in an open configuration;

FIG. 2 is a bottom, perspective-view illustration of the portable BBQ grill, depicting the BBQ grill in an open configuration;

FIG. 3 is a front-view illustration of the portable BBQ grill, depicting the BBQ grill in a closed configuration;

FIG. 4 is a rear-view illustration of the portable BBQ grill, depicting the BBQ grill in a closed configuration;

FIG. 5 is a right, side-view illustration of the portable BBQ grill, depicting the BBQ grill in a closed configuration;

FIG. 6 is a left, side-view illustration of the portable BBQ grill, depicting the BBQ grill in a closed configuration;

FIG. 7 is a top-view illustration of the portable BBQ grill, depicting the BBQ grill in a closed configuration;

FIG. 8 is a bottom-view illustration of the portable BBQ grill, depicting the BBQ grill in a closed configuration;

FIG. 9 is an exploded-view illustration of the portable BBQ grill; and

FIG. 10 is an illustration of a drip tray with its side catch portion; and

FIG. 11 is another illustration of the drip tray with the side catch portion.

### DETAILED DESCRIPTION

The present invention relates to a BBQ grill and, more particularly, to a portable BBQ grill. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

### (1) Description

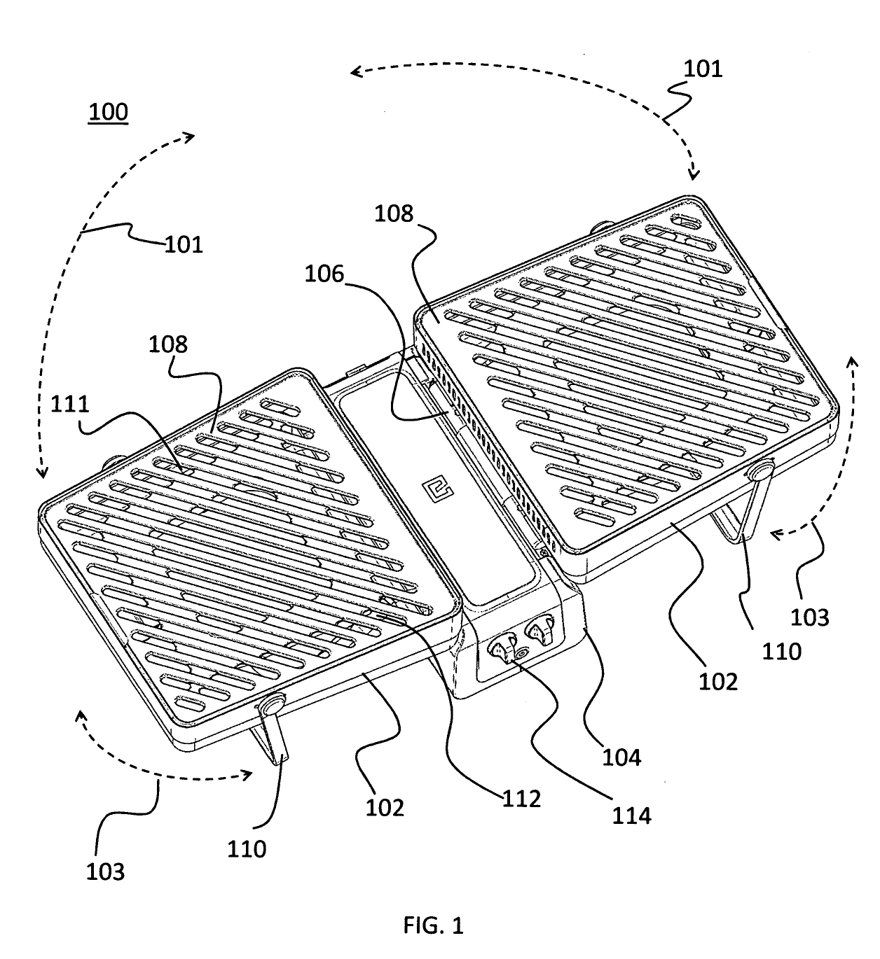

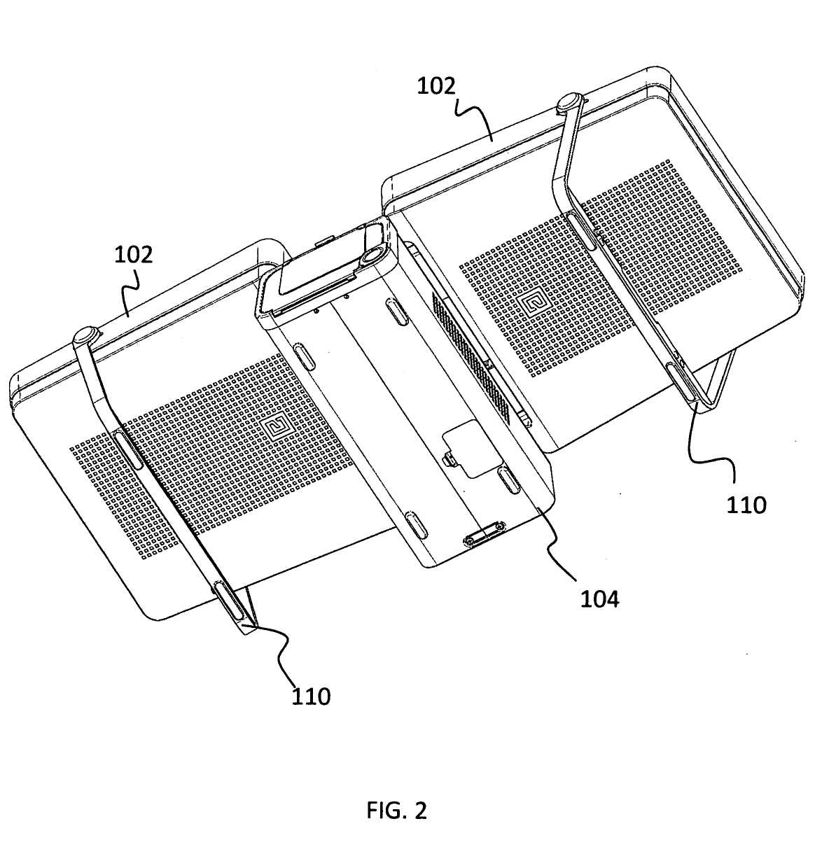

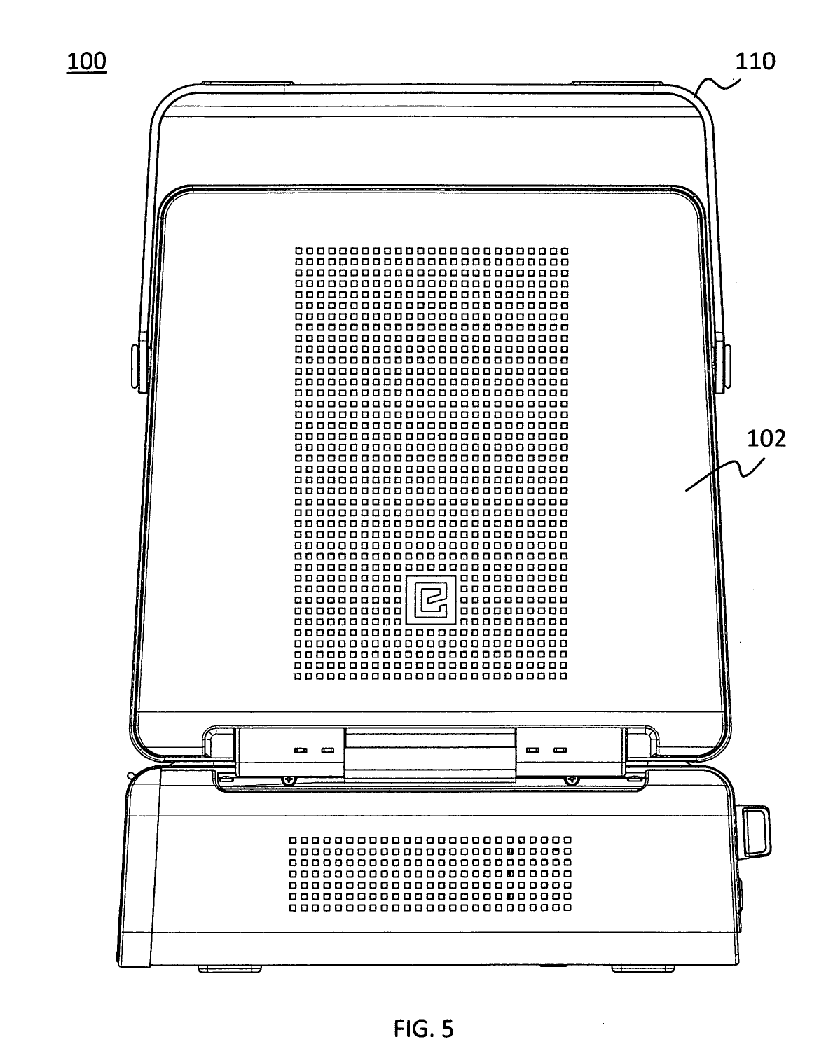

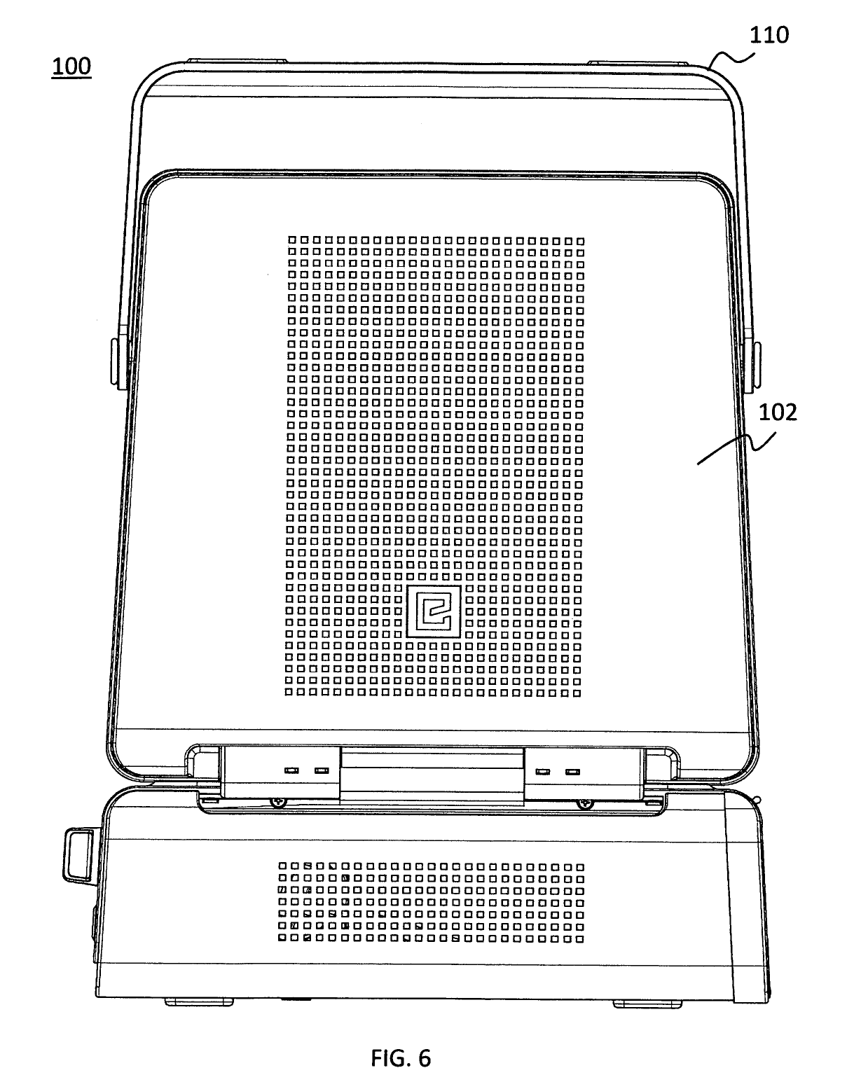

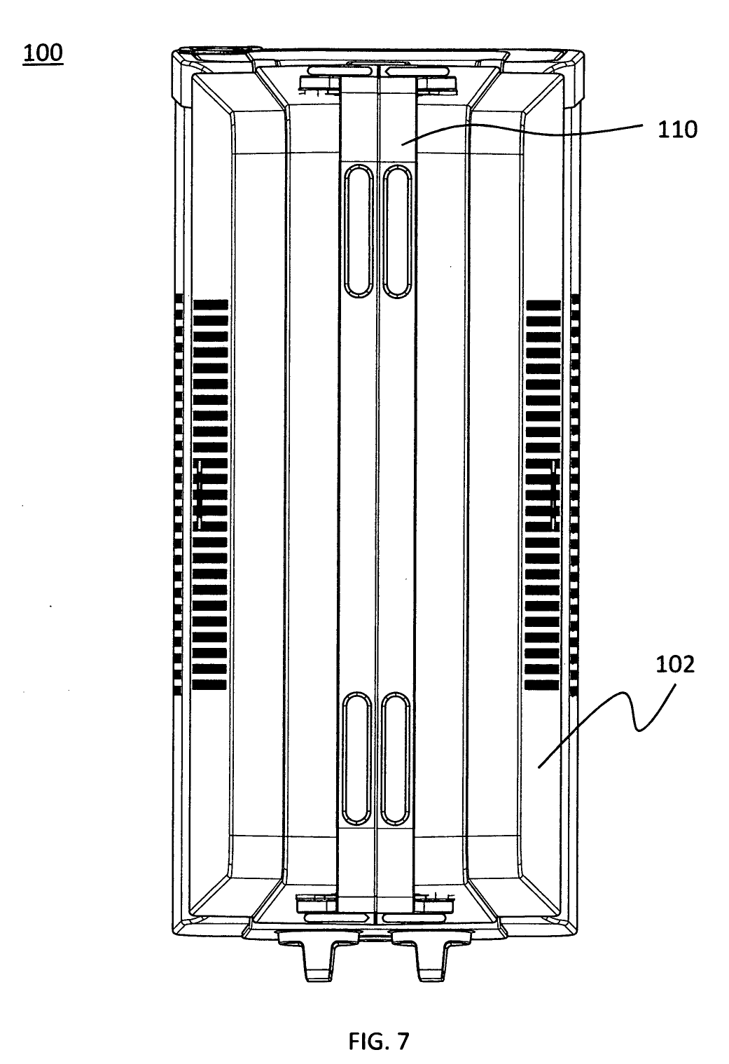

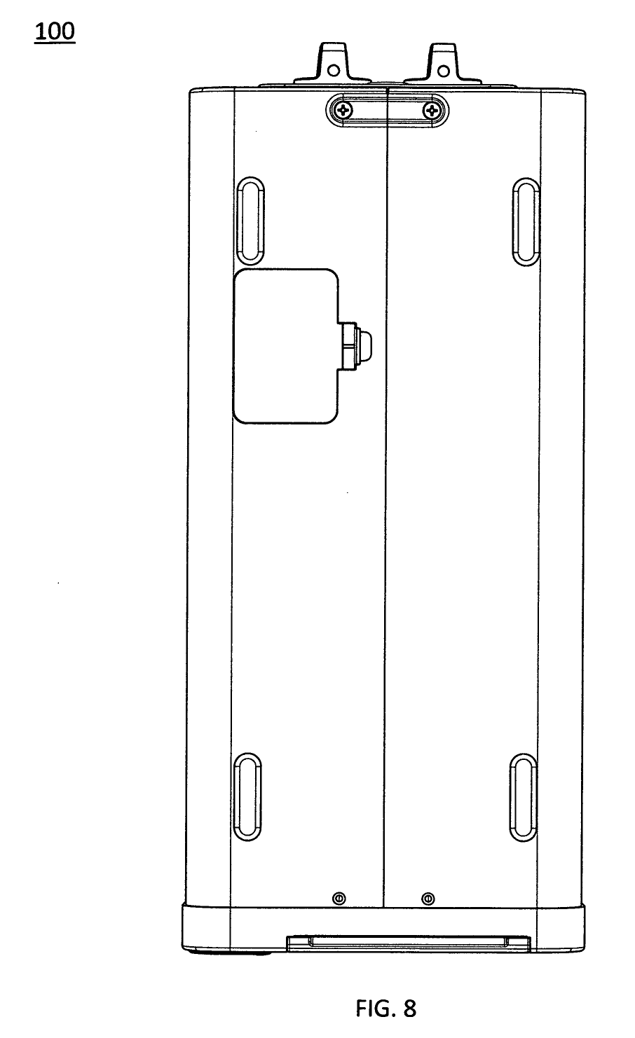

As shown in FIGS. 1 through 9, this disclosure provides a portable BBQ grill 100. More specifically and as shown in FIGS. 1 and 2, the BBQ grill 100 includes a pair of grill housings 102 that are pivotally connected (via a hinge 106 or other pivotal connection) with a lower housing 104. The grill housings 102 and lower housing 104 are desirably formed of any suitably durable material that is heat stable, non-limiting examples of which metals or alloys such as aluminum alloy, or suitable plastics if not exposed directly to flames from the grill.

Each grill housing 102 houses a burner assembly 112 that is pivotally connected with the lower housing 104. Further, each grill housing 102 includes a removable grilling surface 108 that is formed to be heated to grill or cook an item. Holes 111 are formed through the grilling surface 108 to allow grease and other detritus to fall through the grilling surface 108 and into a drip tray (described in further detail below).

In addition to operating as a third leg, the lower housing 104 is formed to receive and contain a gas canister that feeds the burner assemblies 112 with all of the relevant fittings and components. For example and in some embodiments, the lower housing 104 further includes a gas fitting, gas conduits, and a pair of gas controls 114. The pair of gas controls 114 are operable for selectively directing gas to the associated burner assembly 112.

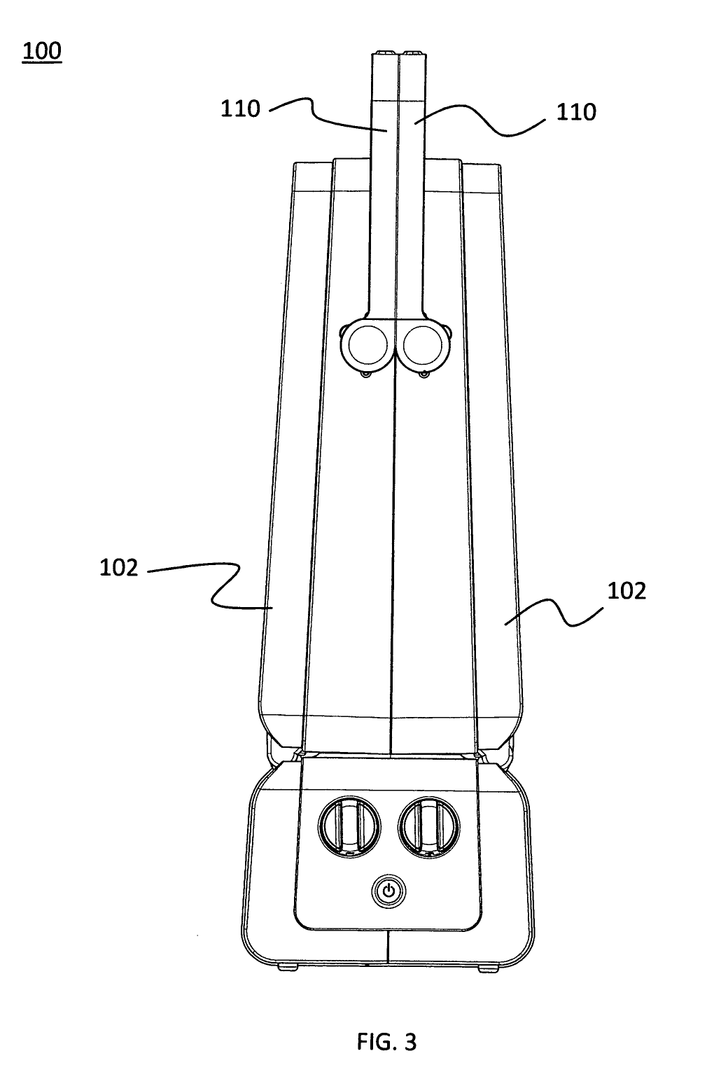

As will become apparent below and as further depicted throughout the figures, the grill housings 102 are pivotal 101 from a closed configuration (as shown in FIGS. 3 through 8) in which the grilling surfaces 108 face one another and an open configuration (as shown in FIGS. 1, 2 and 9) in which the grilling surfaces 108 are substantially horizontal and exposed for grilling.

Each grill housing 102 includes a handle 110 pivotally attached with said grill housing 102. In the open configuration and as depicted, the handles 110 pivot 103 downward to operate as legs to support the BBQ grill 100. Additionally, the lower housing 104 operates as a third leg. Thus, the two handles 110 fold down to operate as two legs in conjunction with the central third leg (formed by the lower housing 104), which collectively provide stable legs for supporting the grill housings 102 above a surface.

Alternatively and as noted above, the grill housings 102 can be pivoted 101 into a closed configuration, with the handles 110 pivoting 103 out and together to collectively form a carrying handle. The closed configuration is depicted in FIGS. 3 through 8, which show front, rear, right, left, top, and bottom-views, respectively, of the BBQ Grill 100. As shown in FIGS. 3 through 8, the grill housings 102 are pivoted together (such that the grilling surfaces face one another) with the handles 110 pivoted toward one another to collectively operate as a unified carrying handle projecting upward from the portable BBQ grill 100. Thus, when in the closed configuration, a user can easily carry the BBQ grill 100 through use of the unified handles 110.

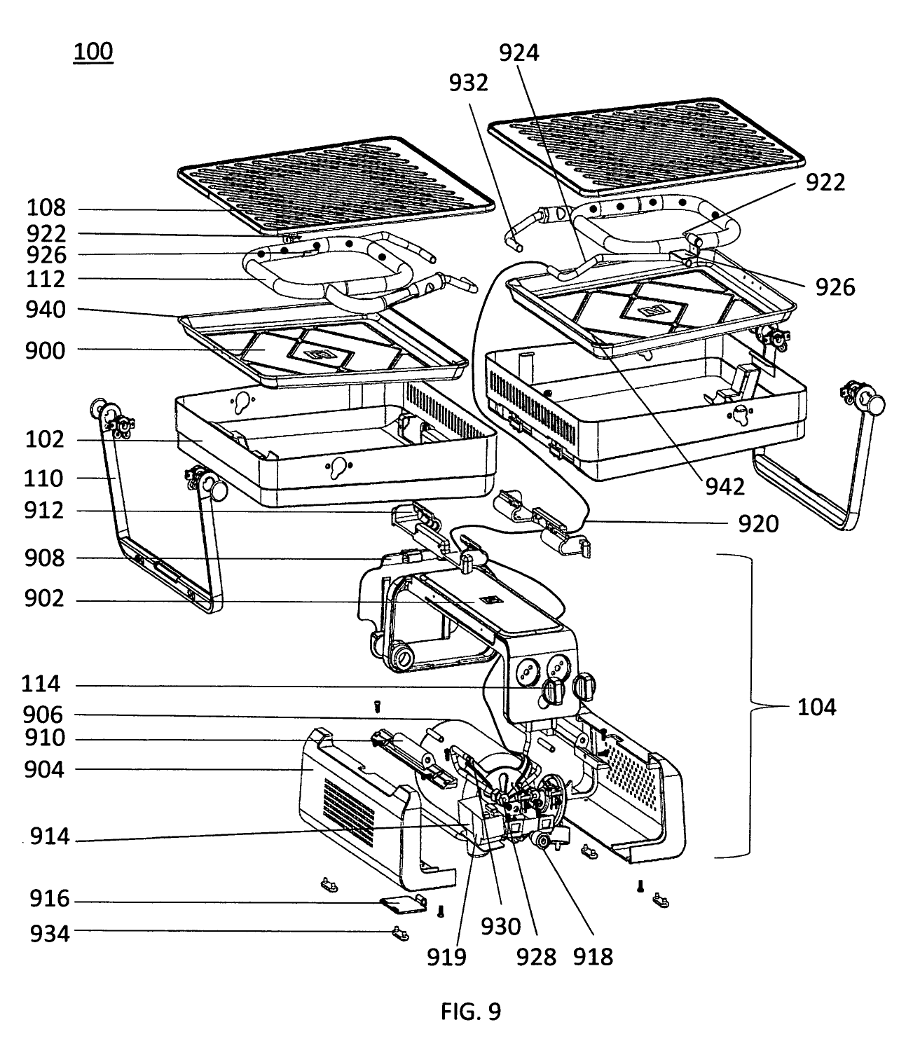

For further understanding, FIG. 9 provides an exploded view illustration depicting various components that form the BBQ grill 100 according to the principles of the present invention. As shown, each grill housing 102 includes a removable drip tray 900 that is positioned beneath the corresponding burner assembly 112 and covered by a removable grilling surface 108. Handles 110 are pivotally attached with each grill housing 102, while each grill housing 102 is pivotally attached with the lower housing 104. It should be understood that the lower housing 104 can be formed in any suitable shape and of any suitable number of components to provide the features and functions as described herein. For example, in this non-limiting embodiment, the lower housing 104 is formed of a housing top 902 and a pair of side covers 904 that are collectively adhered to one another, via screws or any other suitable mechanism or device. Further, rubber feet 934 or other non-skid elements can optionally be positioned on the bottom of the lower housing 104 to provide for suitable stability of the BBQ grill 100.

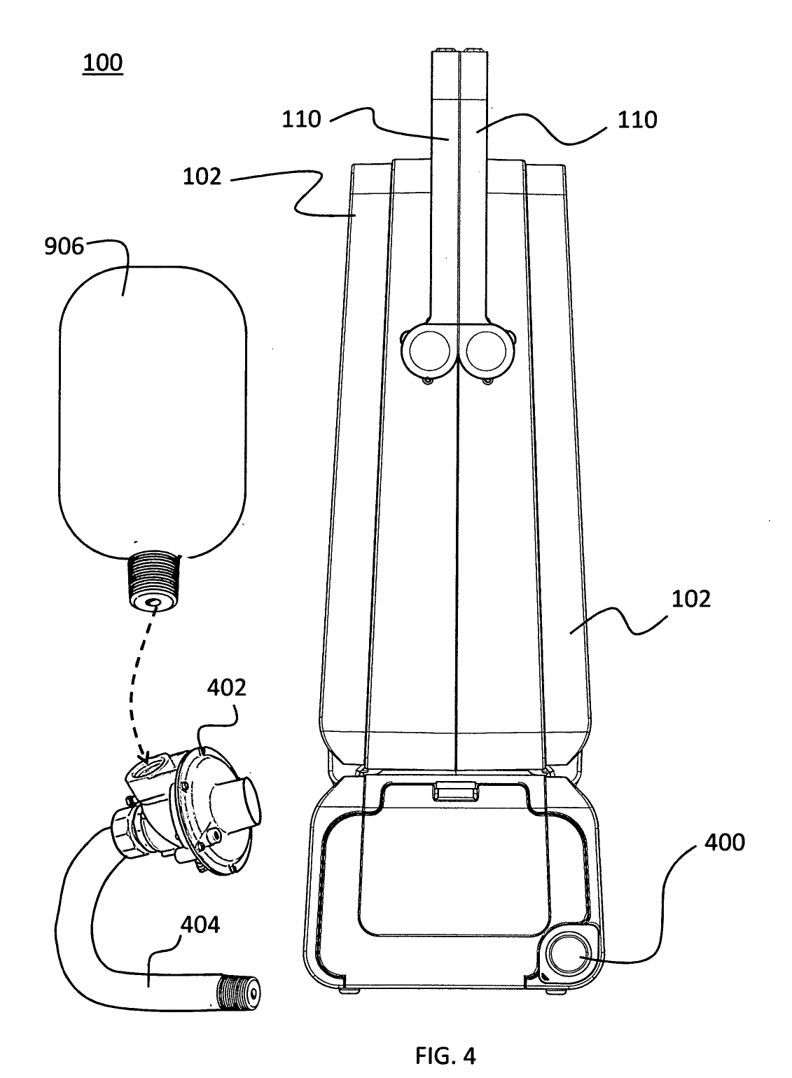

As noted above, the lower housing 104 is formed to accommodate a gas canister 906, which can be selectively sealed within the lower housing 104 via a pivotally attached canister door 908. In one aspect, the gas canister 906 is stored and used while positioned within the lower housing 104. Alternatively and in another aspect, the gas canister 906 is only stored within the lower housing 104 and removed from the lower housing 104 for use. For example and referring again to FIG. 4, the BBQ grill 100 includes a fitting 400 (e.g., threaded aperture) that is fluidically connected with the gas conduits and a T (or any other desired fitting or coupling) that direct gas to the valves (depicted as element 928 in FIG. 9). Thus, in this aspect, a regulator 402 is included along with relevant piping 404 or conduits for securing the regulator 402 against the fitting 400. For example, the pipping 404 can be screwed into the fitting 400, with the gas canister 906 being screwed into the regulator 402. When connected, gas is free to pass from the gas canister 906, through the regulator 402 and piping 404, and through the fitting 400 into the relevant conduits which direct the gas to the valves. It should be noted that the gas canister 906 is any suitable canister operable for connecting with a regulator and containing gas therein, a non-limiting example of which includes a 16.4 ounce propane fuel canister as commonly used for camping stoves, such as those sold by Coleman®.

Referring again to FIG. 9 and as noted above, each grill housing 102 is pivotally connected with the lower housing 104 using any suitable mechanism or device. As a non-limiting example, a lower housing bracket 910 is affixed (via screw, glue, etc.) with each side cover 904 while a grill housing bracket 912 is affixed (via screw, glue, etc.) with each grill housing 102. Each lower housing bracket 910 is pivotally affixed with the corresponding grill housing bracket 912 via, for example, a pin or other suitable pivotal connection means. Thus, the lower housing bracket 910 and grill housing bracket 912 (in addition to the pin or pivotal connection means) collectively form the hinge 106 as depicted in FIG. 1.

The lower housing 104 is also formed to accommodate a battery 914 or other suitable power source to provide for the electric ignition to light the burner assemblies 112. Thus, the BBQ Grill 100 also includes an ignition system. In one aspect, the BBQ Grill 100 includes a piezo starter or piezo ignition and all of the relevant components as commonly understood by those skilled in the art. In another aspect, the BBQ Grill desirably includes a battery-powered spark generator, which uses the voltage from the battery 914 to generate the spark and ignite the burner assemblies 112.

Thus, in this aspect, the BBQ Grill 100 includes all of the relevant components as understood by those skilled in the art to provide for a battery-powered spark generator. As a non-limiting example, a battery cover 916 is pivotally connected with the lower housing 104 to provide access to the battery 914. Further, the battery 914 is electrically connected with a spring-loaded ignitor button 918 that protrudes from the lower housing 104. The spring-loaded ignitor button 918 is connected with a spark generator 919, which is electrically connected (via, for example, a wire 920 (only one of which is depicted)) with an ignition rod 922 that is positioned in the gas flow of each of the burner assemblies 112.

When the ignitor button 918 is depressed, a circuit is closed which causes electricity to pass through the wire 920 and to the ignition rod 922, which generates a spark and ignites the burner assemblies 112 (provided that the gas is turned on via the gas controls 114).

In a desired aspect the wires 920 are concealed in a pivotally connected ignition assembly 924. The ignition assembly 924 is formed of metal piping or any other suitable material for safely protecting and concealing the ignition wires 920 from a flame, etc. On one end, the ignition assembly 924 is pivotally connected with the lower housing 104 (via, for example, by being positioned within the hinge 106 (i.e., between the lower housing bracket 910 and corresponding grill housing bracket 912)). The other end of the ignition assembly 924 includes the ignition rod 922 and is secured against the burner assembly 112 to position the ignition rod 922 proximate the burner assembly 112. As a non-limiting example, the ignition assembly 924 includes a bracket 926 that is affixed with and protrudes from the ignition assembly 924 and rests beneath the burner assembly 112. In other words, when the burner assembly 112 is positioned downward and into the grill housing 102, it contacts and rests against the bracket 926 which secures the burner assembly 112 in sufficient proximity (e.g., approximately one millimeter) to the ignition rod 922 to provide for ignition. Thus, in one non-limiting example, each of the burner assembly 112 and ignition assembly 924 are independently pivotally connected with the lower housing 104.

Regarding gas flow, the BBQ grill 100 includes any suitable mechanism or device for allowing a user to selectively provide the desired amount of gas to each burner assembly 112. As a non-limiting example, each gas control 114 is a dial or knob that is connected with a valve 928. Each valve 928 is fluidly connected (via conduits, piping, fittings, couplings, etc.) with the gas in the gas canister 906. Conduits (piping, etc.) downstream from each valve 928 end in a rotational coupling 930. The rotational coupling 930 includes an o-ring or any other suitable mechanism or device operable for creating a fluidic seal between two components. Each burner assembly 112 includes a coupling sleeve 932 that slides over (or into, in another aspect) the rotational coupling 930. With the o-ring or other sealing mechanism in place between the rotational coupling 930 and the coupling sleeve 932, the burner assembly 112 is then pivotally connected with the rotational coupling 930. Thus, in this example, each burner assembly 112 is pivotally connected with the lower housing 104 via the corresponding rotational coupling 930. Note that the shape of the burner assembly 112 tubing and coupling sleeve 932 allow the coupling sleeve 932 to pass laterally through the grill housing bracket 912 to engage and connect with the rotational coupling 930 to allow the burner assemblies to rotate up and down between the open and closed configurations.

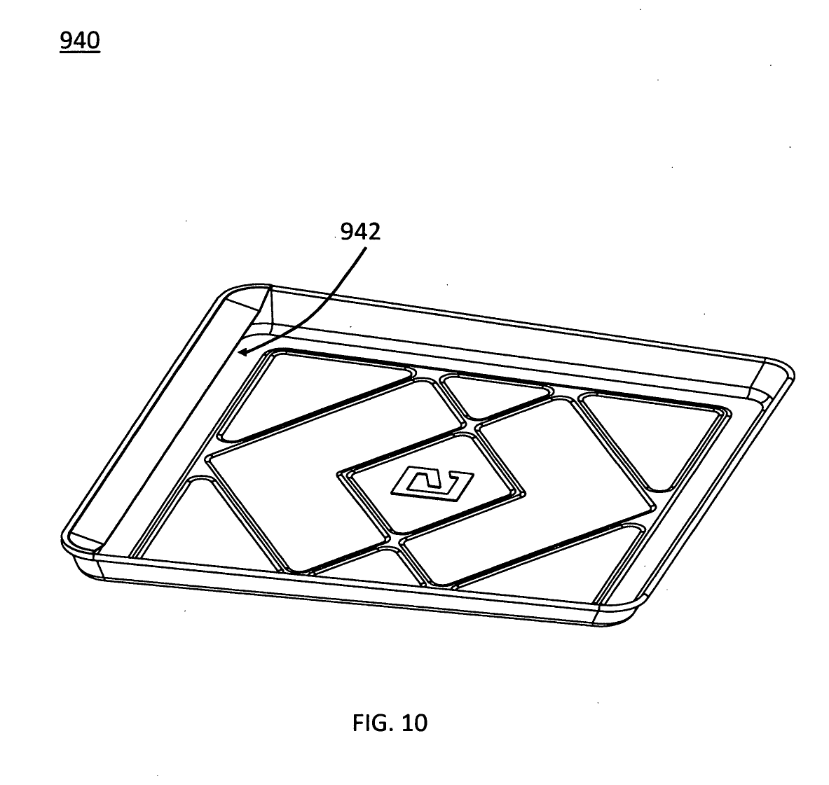

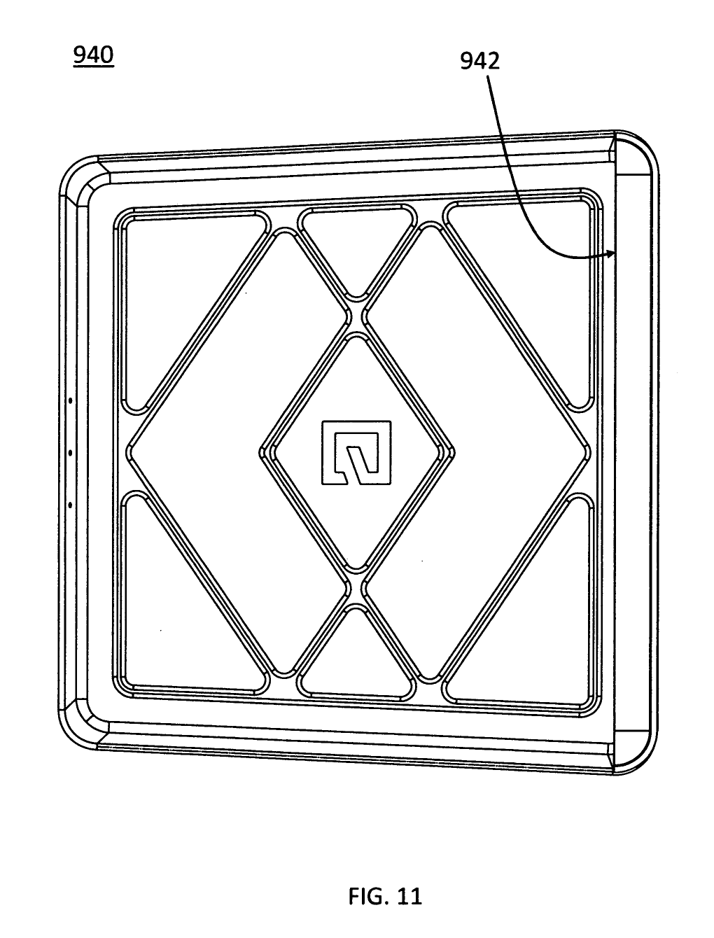

As noted above, the BBQ grill 100 also includes a removable grease drip tray 940 with a side catch portion 942. When the BBQ grill 100 is in the open position, the side catch portion 942 acts as a side wall to the drip tray. However, when the BBQ grill 100 is folded into the closed configuration, with the grilling surfaces 108 facing each other and the handle 110 at the top of the unit, the side catch portions 942 are positioned at the bottom of the drip tray 940 and operate as vessels or basins to catch any grease or other material that may drip or slide down the drip tray 940. FIGS. 10 and 11 further illustrate the drip tray 940 and its side catch portion 942. Thus, as can be appreciated, described is a unique portable BBQ grill 100 incorporating all of the novel components and features as illustrated in FIGS. 1 through 11 and described herein.

While this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. A portable BBQ grill, comprising:
a pair of grill housings and a lower housing, each grill housing pivotally connected with the lower housing and having a grilling surface, wherein the grilling housings are pivotal from a closed configuration in which the grilling surfaces face one another and an open configuration in which the grilling surfaces are substantially horizontal and exposed for grilling; and
a pair of handles, each handle pivotally attached with one of the grill housings, wherein when in the closed configuration, the pair of handles pivot toward one another to collectively operate as a carrying handle projecting upward from the portable BBQ grill, and wherein when in the open configuration, the pair of handles pivot downward to provide a pair of legs that, in conjunction with the lower housing, provide three legs upon which the portable BBQ grill rests.

2. The portable BBQ grill as set forth in claim 1, further comprising a pair of drip trays, each of which is formed to fit within a grill housing, and wherein each drip tray includes a bottom portion and a side catch portion such that when the portable BBQ grill is in the open configuration, the bottom portion rests below the grilling surface and the side catch portion acts as a side wall to the drip tray and when the BBQ grill is folded into the closed configuration, with the grilling surfaces facing each other, the side catch portions are positioned at the bottom of the drip tray and operate as basins to catch any grease or other material that may drip or slide down the drip tray.

3. The portable BBQ grill as set forth in claim 2, wherein the grilling surfaces are removable grilling surfaces that are detachably attachable with the respective grill housing.

4. The portable BBQ grill as set forth in claim 3, further comprising a pair of burner assemblies, each burner assembly being positioned within a grill housing and pivotally connected with the lower housing.

5. The portable BBQ grill as set forth in claim 4, wherein the lower housing is formed to receive and contain a gas canister therein, and wherein the lower housing further includes a pair of gas controls operable for selectively directing gas to the pair of burner assemblies.

6. The portable BBQ grill as set forth in claim 5, further comprising a pair of ignition assemblies, wherein each ignition assembly is pivotally connected with the lower housing and includes an ignition rod positioned proximate the burner assembly.

7. The portable BBQ grill as set forth in claim 6, further comprising an ignitor button and spark generator attached with the lower housing, wherein a wire is electrically connected with and between the spark generator and the ignition rod, with the wire partially concealed within the ignition assembly.

8. The portable BBQ grill as set forth in claim 7, wherein the ignition assembly includes a bracket that is affixed with the ignition assembly and rests beneath the burner assembly, such that when the burner assembly is positioned downward and into the grill housing, the burner assembly contacts and rests against the bracket which secures the burner assembly proximate the ignition rod.

9. The portable BBQ grill as set forth in claim 8, further comprising one or more conduits connected with the lower housing, each conduit ending in a rotational coupling, and wherein each burner assembly includes a coupling sleeve that slides into engaging contact with the rotational coupling to provide a sealed and pivotal connection between the rotational coupling and the coupling sleeve.

10. The portable BBQ grill as set forth in claim 9, wherein a grill housing bracket is affixed with each grilling housing and a pair of lower housing brackets are affixed with the lower housing, such that the grill housing brackets are pivotally connected with the corresponding lower housing brackets to provide the pivotal connection between each grill housing and the lower housing, and wherein the burner assembly and coupling sleeve are shaped such that the coupling sleeve passes laterally through the grill housing bracket to engage and connect with the rotational coupling to allow the burner assemblies to rotate up and down between the open and closed configurations.

11. The portable BBQ grill as set forth in claim 1, further comprising a pair of burner assemblies, each burner assembly being positioned within a grill housing and pivotally connected with the lower housing.

12. The portable BBQ grill as set forth in claim 11, further comprising a pair of ignition assemblies, wherein each ignition assembly is pivotally connected with the lower housing and includes an ignition rod positioned proximate the burner assembly.

13. The portable BBQ grill as set forth in claim 12, further comprising an ignitor button and spark generator attached with the lower housing, wherein a wire is electrically connected with and between the spark generator and the ignition rod, with the wire partially concealed within the ignition assembly.

14. The portable BBQ grill as set forth in claim 12, wherein the ignition assembly includes a bracket that is affixed with the ignition assembly and rests beneath the burner assembly, such that when the burner assembly is positioned downward and into the grill housing, the burner assembly contacts and rests against the bracket which secures the burner assembly proximate the ignition rod.

15. The portable BBQ grill as set forth in claim 11, wherein the lower housing is formed to receive and contain a gas canister therein, and wherein the lower housing further includes a pair of gas controls operable for selectively directing gas to the pair of burner assemblies.

16. The portable BBQ grill as set forth in claim 1, wherein the grilling surfaces are removable grilling surfaces that are detachably attachable with the respective grill housing.

17. The portable BBQ grill as set forth in claim 1, further comprising one or more conduits connected with the lower housing, each conduit ending in a rotational coupling, and wherein each burner assembly includes a coupling sleeve that slides into engaging contact with the rotational coupling to provide a sealed and pivotal connection between the rotational coupling and the coupling sleeve.

18. The portable BBQ grill as set forth in claim 17, wherein a grill housing bracket is affixed with each grilling housing and a pair of lower housing brackets are affixed with the lower housing, such that the grill housing brackets are pivotally connected with the corresponding lower housing brackets to provide the pivotal connection between each grill housing and the lower housing, and wherein the burner assembly and coupling sleeve are shaped such that the coupling sleeve passes laterally through the grill housing bracket to engage and connect with the rotational coupling to allow the burner assemblies to rotate up and down between the open and closed configurations.
